(19) United States
(12) Patent Application Publication
(10) Pub. No.: US 2026/0298475 A1
(43) Pub. Date: Oct. 1, 2026

(54) UNIVERSAL BATTERY SYSTEM FOR CORDLESS DEVICES

(71) Applicant: Enerco Group, Inc., Cleveland, OH (US)

(72) Inventors: Nickolas Quinn, North Ridgeville, OH (US); Michael Allen, Cleveland, OH (US)

(73) Assignee: Enerco Group, Inc., Cleveland, OH (US)

(21) Appl. No.: 19/576,502

(22) Filed: Mar. 24, 2026

Related U.S. Application Data
(60) Provisional application No. 63/954,961, filed on Jan. 6, 2026.
(60) Provisional application No. 63/777,840, filed on Mar. 26, 2025.

(51) Int. Cl. F24C 3/14; F24H 3/04; H01R 31/06

(52) U.S. Cl. CPC F24C 3/14; F24H 3/0488; H01R 31/06

(57) ABSTRACT

The present disclosure relates to universal battery adapter systems. A battery adapter system may include a rail interfacing adapter having a power interface rail system and a common terminal interface and one of a plurality of battery interfacing adapter having one of a plurality of battery-specific terminal interfaces and a one of a plurality of battery-specific rail systems. The battery-specific rail system is configured to electrically couple a battery to battery-specific terminal interface. The common terminal interface is configured to receive the battery-specific terminal interface and electrically couple the battery interfacing adapter to a power interface of an electronic device.

### CROSS-REFERENCE TO RELATED APPLICATIONS

This application claims priority to U.S. patent application no. 63/954,961, entitled UNIVERSAL BATTERY SYSTEM FOR CORDLESS DEVICES, filed Jan. 6, 2026, and claims priority to U.S. patent application no. 63/777,840, entitled CORDLESS FORCED AIR LIQUID PROPANE HEATER WITH RAIL SYSTEM, filed Mar. 26, 2025, all of which are incorporated herein by reference.

### BACKGROUND

Cordless power tools typically require proprietary battery packs, forcing a user to stay within the company’s ecosystem. Seeing an opening in the market, some third-party companies have produced battery adapters that enable a user to mix and match their battery pack with a cordless tool from another brand. However, current adapters are specifically tailored to swap one proprietary battery pack with another. Not only are the battery adapters limiting, they can be cumbersome to remove if trying to replace with another battery.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are provided herein for a battery adapter that can interface with multiple styles of battery packs. Such a battery adapter can allow a user to use whichever battery style or brand they prefer, while also offering ease of removing and replacing the battery with another battery of the same brand. For example, battery packs are typically used with portable tools and appliances, such as drill/drivers, saws, heaters, and much more. The systems described herein can provide a battery pack system that is compatible with each of the tools and appliances across multiple, battery platforms, which are often proprietary to each different brand.

In one implementation, a battery adapter system may include a rail interfacing adapter having a power interface rail system and a common terminal interface and one of a plurality of battery interfacing adapter having one of a plurality of battery-specific terminal interfaces and a one of a plurality of battery-specific rail systems. The battery-specific rail system is configured to electrically couple a battery to battery-specific terminal interface. The common terminal interface is configured to receive the battery-specific terminal interface and electrically couple the battery interfacing adapter to a power interface of an electronic device.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a view of the forced air liquid propane heater with a battery pack installed.

FIG. 2 is an alternative view of the forced air liquid propane heater without a battery pack installed.

FIGS. 3-5 are views of the battery adapter assembled and disassembled.

FIG. 6 is a view forced air liquid propane heater with respect to the battery adapter and battery pack.

FIGS. 7 and 8 are views of the battery adapter and battery pack before and after being installed into the forced air liquid propane heater.

FIG. 9 is a close-up view of the battery pack installed into the forced air liquid propane heater.

FIGS. 10 and 11 show alternative battery packs with their respective battery adapters.

FIGS. 12 shows one style of battery pack being compatible with multiple different power tools.

FIG. 13 shows one power tool being compatible with multiple different battery packs.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Cordless power tools and other devices and portable appliance that may require a battery pack are typically locked into the ecosystem or battery platform designed by the same brand or company. That is, a Brand A tool, device or appliance will only be able to accept a Brand A battery pack, as the mechanical design is so configured to prevent use of non-Brand A battery pack. So, users are typically required to only use battery packs from the same brand, as the platforms do not typically allow cross platform use, due to the physical and mechanical designs. If one desires to use a battery pack that is not from the same brand as the tool, the user may be able to use a third-party adapter. The downside to current adapters is that they only work on a specific brand. That is, a third-party adapter may be specifically designed to be compatible with one brand of tools and a one specific different brand of battery packs, such as brand A and battery pack B only. A battery adapter that is capable of supporting multiple types of batteries, over multiple brands, for multiple tools/appliances, would offer far more versatility for consumers. One will readily appreciate the benefits of a battery adapter with a unique rail system capable of interfacing with multiple battery pack styles.

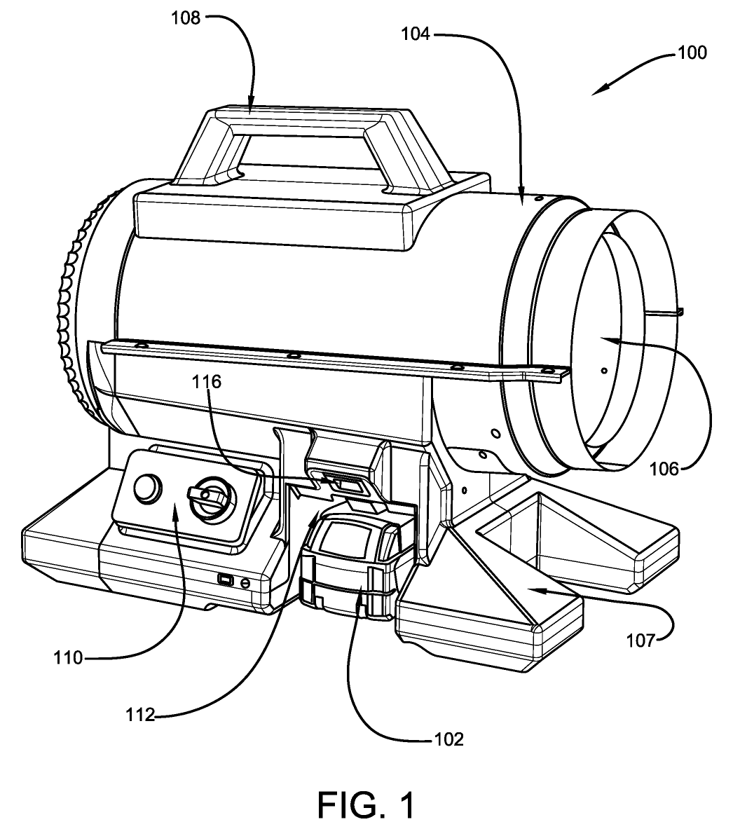

FIG. 1 shows one example of a cordless forced air liquid propane (FALP) heater 100 with a battery pack 102 installed. The FALP heater 100 includes a housing 104 comprising of a burner assembly 106 supported by a base 107. The burner assembly 106 may be cylindrical in shape to allow propane and combustion air to be drawn in and mixed prior to ignition. Through the venturi effect, the FALP heater 100 is able to create a stable flame without requiring a blower. The base 107 may have one or more legs 111 to provide stability for the burner assembly when placed on the ground. The base 107 may house the control panel 110, the power interface 112, a release mechanism 116, and any additional features that support the use of the FALP. The control panel 110 may contain a dial to operate the heater, such as for starting and stopping, and to adjust the flow of the gas into the burner assembly 106 and button to ignite the propane. The control panel 110 is not limited to a dial and button, and may use other control methods, such as but not limited to, a slide switch, a digital control panel, or a membrane keypad. The power interface 112 supplies electrical power to the heater 100. The housing 104 also includes a handle 108 for carrying the FALP heater 100. The handle 108 may fold down for easier storage.

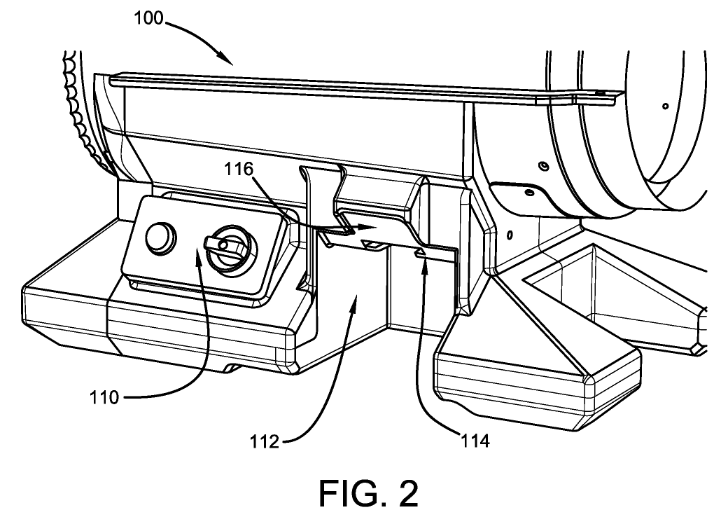

FIG. 2 shows a closer view of the FALP heater 100 without the battery pack 102 installed. The power interface 112 is tucked inside an opening in the base 107 and includes battery rail system 114. The battery rail system 114 overhangs over the opening in the base to allow easy access while the FALP heater 100 is placed on the ground. The battery rail system 114 uses a rail system that is intended to not be compatible with known and typical batteries used for this and similar applications, such as for portable power tools and the like. Instead, as described herein, a battery adapter can be designed to couple with the rail system 114. The battery rail system 114 has two downward facing rails on opposite sides of the base opening. A flange 124 may be below the rails to help hold and support a battery adapter during and after installation. Further, various of these battery adapters can be tailored to each known (and designed for future) battery styles, such as those provided by current battery manufacturers for portable power equipment.

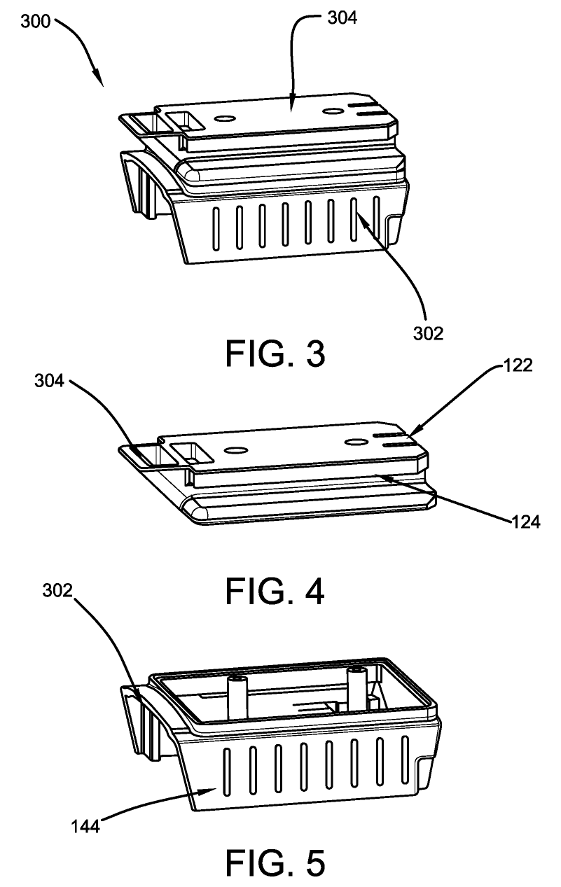

FIGS. 3-5 show a universal battery adapter 300. The battery adapter 300 can be made of two parts, a rail interfacing adapter 304 and a battery interfacing adapter 302.

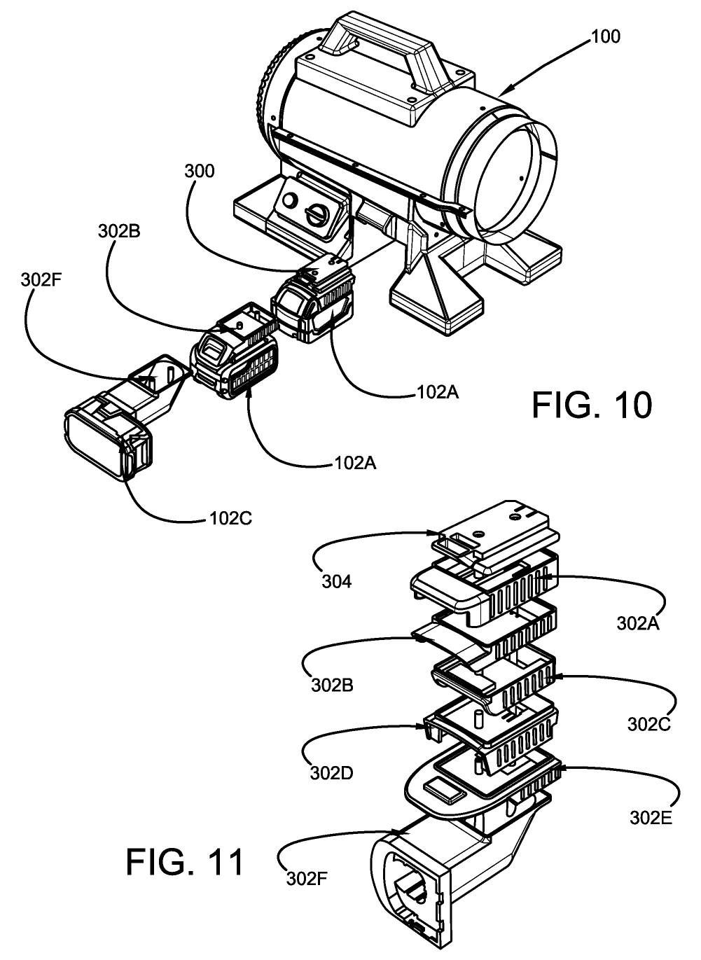

The battery interfacing adapter 302 may be one of a plurality of battery interfacing adapters 302A-F (as shown later in FIG. 11). Each battery interfacing adapter 302 may be designed to work with a specific brand or style of battery. The battery interfacing adapter 302 has terminal interface 342 and battery rail system 344 for electrically coupling with a specific branded battery pack 102 (as shown later in FIG. 10). Each battery interfacing adapter 302 has a different battery-specific rail system 344. In most battery systems, the battery adapter 300 interfaces with the battery pack 102 by sliding the battery pack 102 horizontally along the battery-specific rail system 344. However, some branded battery packs may have the battery pack slide perpendicular, or in other directions, to the battery adapter 300. The terminal interface 342 is located on top of the battery interfacing adapter 302 and is consistent across all battery types. The terminal interface 342 may be a stamped terminal having blade contacts isolated by plastic that protrude upward to be received by the rail interfacing adapter 304.

The rail interfacing adapter 304 has a common terminal interface 322 and a rail system 324 that is compatible with the rail system found in the battery rail system 344. The rail system 324 interfaces with the power interface 112 of the FALP heater. The rail system 324 is not compatible with known and typical batteries, and is designed only to interface with the power interface 112. The rail system 324 is slid into position along the rails of the power interface 112, where may be locked in place. The rail interfacing adapter may be released upon pressing the release mechanism 116. Given the common terminal interface 322, the rail interfacing adapter 304 is compatible with each battery interfacing adapter 302. The blade contacts of the rail interfacing adapter 304 fit into the common terminal interface 322 to allow the transfer of the positive and negative terminal from each battery 102 through the adapter to the power interface 112 of the FALP heater 100 or a different cordless device, such as a portable tool, appliance, or the like. The rail interfacing adapter 304 may also include flanges extending on both sides of the rail interfacing adapter 304. These flanges allow the adapter to rest on the flanges of the power interface 112.

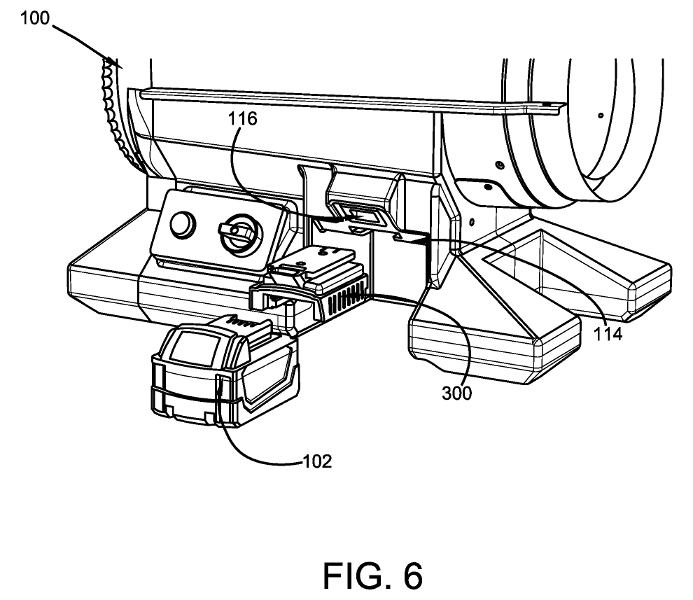

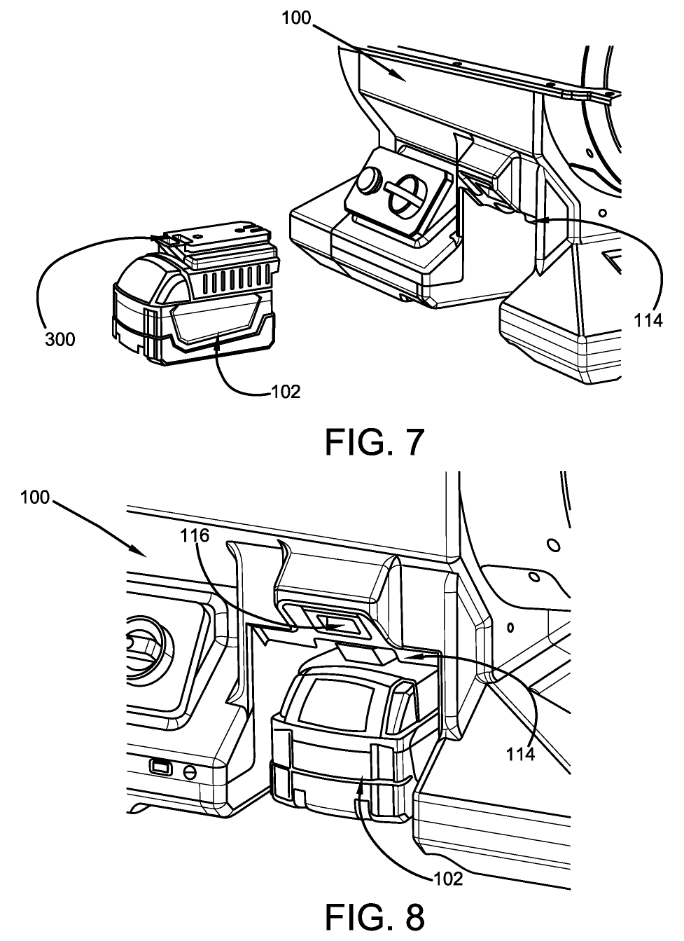

FIGS. 6-8 show the sequence of installing the battery pack 102 into the FALP heater 100. FIG. 6 shows an overall view of the battery pack 102 and the battery adapter 300 with respect to the FALP heater 100. FIG. 7 shows what would be the first step, which is installing the battery pack 102 to the battery adapter 300. The battery adapter 300 can be engaged with (e.g., slide onto) the battery pack 102, and can be selectively locked into place. That is, for example, the battery adapter 300 can be selectively engaged in a fixed manner onto the battery pack 102. In this way, the battery pack 102 and adapter 300 are ready for installation with the heater. FIG. 8 shows the battery pack 102 after being installed into the FALP heater 100. Once the battery pack 102 and the battery adapter 300 are connected, the rail interfacing adapter 304 interfaces with the battery rail system 114, allowing the battery pack 102 to engage with (e.g., slide into the housing of) the FALP heater 100. A spring-loaded clip may be used to help to hold the battery adapter 300 in place in a selectively, fixed manner during use.

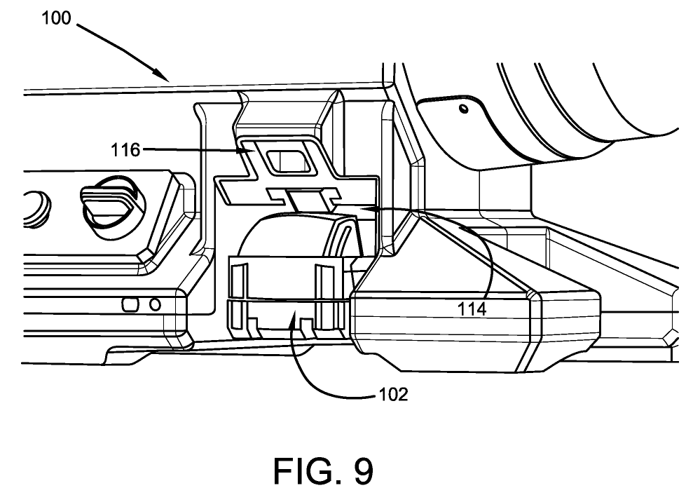

FIG. 9 is an alternative view of the FALP heater 100 with the battery pack 102 installed. In this view, the release mechanism (e.g., button) 116 is more prominently visible. The release mechanism 116 can be part of a latching system that helps to engage and release a latch holding the battery adapter 300 in place when activated. The release mechanism 116 works similarly to a latch system found on most batteries. An additional benefit to the latching system is it also allows the battery 102 to be removed without the battery adapter 300. That is, for example, the battery 102 can be released while the adapter 300 remains in place in the housing 104 of the heater 100. This feature enables the ability to swap a battery 102 with another of the same style while leaving the battery adapter 300 attached to the FALP heater 100.

FIGS. 10-11 help to visually demonstrate multiple battery interfacing adapters 302A-F freestanding or connected to their respective battery pack 102A-C. As previously described, each battery pack style has a proprietary terminal interface and rail system specific to the battery style. Therefore, a complementary battery interfacing adapter 302 may include a terminal interface and rail system to accommodate that battery style. The most common method of interfacing the adapter with the battery is through sliding the battery horizontally onto the rails of the battery adapter, but it is not the only method. The rail interfacing adapter 304 portion of the battery adapter 300 has a common terminal interface 322 that is compatible with each battery interfacing adapter 302 style.

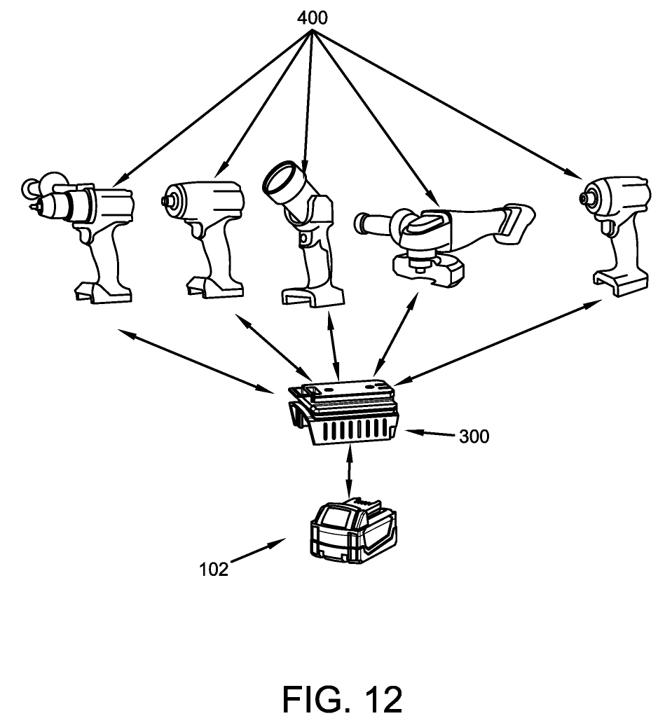

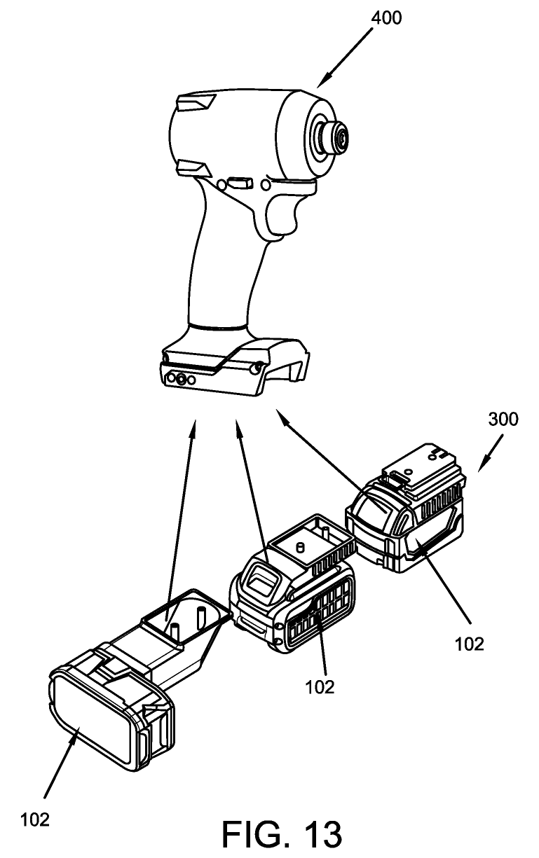

FIGS. 12-13 illustrate the versatility of the battery adapter system. FIG. 12 illustrates how the battery adapter 300 can use a battery pack of a specific brand of battery 102 from a proprietary battery pack platform with multiple different cordless power tools 400. In this example, all of the power tools 400 are capable of receiving and interfacing with the rail interfacing adapter 300 because of the common terminal interface 322.

FIG. 13 illustrates and example implementation where multiple different branded battery packs 102, each with a different, proprietary battery platform, can all work with one cordless power tool or appliance 400, regardless of the brand of the tool or platform. The stamped terminals inside of the battery adapter 300 are able to transfer power through the positive and negative terminal from any battery 102 through the adapter 300 to a power interface of the cordless device 400.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A universal battery adapter system comprising:
a rail interfacing adapter having a power interface rail system and a common terminal interface;
one of a plurality of battery interfacing adapters having a second common terminal interface and one of a plurality of battery-specific rail systems,
wherein the battery-specific rail system is configured to electrically couple a power source to the battery-specific terminal interface, and
wherein the first common terminal interface is configured to receive the second common terminal interface and electrically couple the battery interfacing adapter to a power interface of an electronic device.

2. The universal battery adapter system of claim 1, the rail interfacing adapter further comprising two outwardly extending flanges on opposite sides.

3. The universal battery adapter system of claim 1, wherein the second common terminal interface of the battery interfacing adapter further comprises stamped terminals protruding upward that are received by the first common terminal interface of the rail interfacing adapter.

4. The universal battery adapter system of claim 1, wherein the battery-specific rail system runs vertically and interfaces with the power source by vertically sliding the power source along the battery-specific rail system.

5. The universal battery adapter system of claim 1, wherein the battery-specific rail system runs horizontally and interfaces with the power source by horizontally sliding the power source along the battery-specific rail system.

6. The universal battery adapter system of claim 1, wherein each of the plurality of battery interfacing adapters has a different battery-specific rail system.

7. A power tool and battery adapter system comprising:
a housing including a burner assembly and a base;
a control panel for operating a burner disposed within the burner assembly;
a power interface for connecting indirectly to a plurality of power sources through a battery adapter, the power interface having a battery adapter rail system configured to receive the battery adapter, and the battery adapter including a rail interfacing adapter and one of a plurality of battery interfacing adapters,
wherein the rail interfacing adapter includes a power interface rail system configured to connect to the battery adapter rail system of the power interface the and a first common terminal interface configured to connect to one of a plurality of battery interfacing adapters,
where the plurality of battery interfacing adapters have a second common terminal interface and one of a plurality of battery-specific rail systems,
wherein the battery-specific rail system is configured to electrically couple the power source to the battery-specific terminal interface, and
wherein the first common terminal interface is configured to receive the second common terminal interface and electrically couple the selected battery interfacing adapter to the power interface of the power tool.

8. The power tool and battery adapter system of claim 7, further comprising:
a handle on top of the burner assembly,
wherein the burner assembly is cylindrical in shape, sits on top of the base, and has an opening on one end of the burner assembly, and
wherein the base has two or more legs to support the burner assembly.

9. The power tool and battery adapter system of claim 7, the power interface further including two prongs on opposite sides of the power interface protruding inwardly toward the opposite prong and configured to support the battery adapter when received by the battery rail system.

10. The power tool and battery adapter system of claim 7, the power interface further including a release mechanism configured to latch to engage or release the battery adapter.

11. The power tool and battery adapter system of claim 7, the rail interfacing adapter further comprising two outwardly extending flanges on opposite sides .

12. The power tool and battery adapter system of claim 7, wherein the second common terminal interface of the battery interfacing adapter further comprises stamped terminals protruding upward that are received by the first common terminal interface of the rail interfacing adapter.

13. The power tool and battery adapter system of claim 7, wherein the battery adapter is configured to disconnect the battery from the battery adapter without disconnecting the battery adapter from the power tool.

14. The power tool and battery adapter system of claim 7, wherein each of the plurality of battery interfacing adapters has a different battery-specific rail system.

15. The power tool and battery adapter system of claim 7, wherein the battery-specific rail system runs horizontally and interfaces with the power source by horizontally sliding the power source along the battery-specific rail system.

16. The power tool and battery adapter system of claim 7, wherein the battery-specific rail system runs vertically and interfaces with the power source by vertically sliding the power source along the battery-specific rail system.

17. A portable heater comprising:
a housing including a burner assembly and a base;
a control panel for operating a burner disposed within the burner assembly; and
a power interface for connecting indirectly to a plurality of power sources, the power interface to include:
a battery rail system configured to receive a battery adapter, wherein the battery adapter electrically couples the power interface to a battery such that the battery delivers power through the battery adapter to the power interface.

18. The portable heater of claim 1, the housing further comprising:
a handle on top of the burner assembly,
wherein the burner assembly is cylindrical in shape, sits on top of the base, and has an opening on one end of the burner assembly, and
wherein the base has two or more legs to support the burner assembly.

19. The portable heater of claim 1, the power interface further comprising two prongs on opposite sides of the power interface protruding inwardly toward the opposite prong and configured to support the battery adapter when received by the battery rail system.

20. The portable heater of claim 1, the power interface further including a release mechanism configured to latch to engage or release the battery adapter.
